(19) United States
(12) Patent Application Publication
(10) Pub. No.: US 2024/0249515 A1
(43) Pub. Date: Jul. 25, 2024

(54) METHOD AND APPARATUS FOR TRAINING IMAGE RECOGNITION MODEL, DEVICE, AND MEDIUM

(71) Applicant: Tencent Technology (Shenzhen) Company Limited, Shenzhen (CN)

(72) Inventors: Zhongyi YANG, Shenzhen (CN); Sen YANG, Shenzhen (CN); Jinxi XIANG, Shenzhen (CN); Jun ZHANG, Shenzhen (CN); Xiao HAN, Shenzhen (CN)

(21) Appl. No.: 18/626,165

(22) Filed: Apr. 3, 2024

Related U.S. Application Data
(63) Continuation of application No. PCT/CN23/88131, filed on Apr. 13, 2023.

(30) Foreign Application Priority Data
May 17, 2022 (CN) 202210533141.4

(51) Int. Cl. G06V 10/82; G06T 7/00

(52) U.S. Cl. CPC G06V 10/82; G06T 7/0012; G06T 2207/20081; G06T 2207/20084; G06T 2207/30024; G06T 2207/30096; G06V 2201/032

(57) ABSTRACT

A method for training an image recognition model is performed by a computer device. The method includes: obtaining a sample image and a corresponding sample label; obtaining a sample image patch bag of sample image patches corresponding to the sample image, the sample patch bag having a bag label corresponding to the sample label of the sample image; performing feature analysis on the sample patch bag and the sample image patches in the sample patch bag, respectively, by using an image recognition model; determining a relative entropy loss, a first cross entropy loss corresponding to the sample patch bag and a second cross entropy loss corresponding to the sample image patches based on corresponding bag feature analysis and patch analysis results, respectively; and training the image recognition model based on the relative entropy loss, the first cross entropy loss, and the second cross entropy loss.

### CROSS-REFERENCE TO RELATED APPLICATIONS

This application is a continuation application of PCT Patent Application No. PCT/CN2023/088131, entitled “METHOD AND APPARATUS FOR TRAINING IMAGE RECOGNITION MODEL, DEVICE, AND MEDIUM” filed on Apr. 13, 2023, which claims priority to Chinese Patent Application No. 202210533141.4, entitled “METHOD AND APPARATUS FOR TRAINING IMAGE RECOGNITION MODEL, DEVICE, AND MEDIUM” filed on May 17, 2022, all of which is incorporated by reference in its entirety.

### FIELD OF THE TECHNOLOGY

Embodiments of this application relate to the field of machine learning, and in particular, to a method and apparatus for training an image recognition model, a device, and a medium.

### BACKGROUND OF THE DISCLOSURE

Image recognition refers to a technology of recognizing image content in an image. For example, whether an animal is included in an image is recognized, and if the animal is included in the image, a location of the animal in the image is recognized. An image recognition model is usually configured to recognize image content.

In related arts, image recognition may also be applied to a process of a medical auxiliary diagnosis. A medical pathological image is inputted to an image recognition model and information about lesions in the medical pathological image is outputted. Due to a large amount of pixel data in a single medical pathological image, it is usually necessary to extract patches from the medical pathological image and recognize each patch separately, to obtain a comprehensive recognition result.

When whether the lesion is positive or negative is recognized, the medical pathological image is negative for a lesion if all patches are recognized as negative, and the medical pathological image is positive for a lesion if any patch is recognized as positive. Therefore, when image recognition is performed by using the image recognition model in related arts, it is largely affected by accuracy of the image recognition model, and problems such as a low screening negative rate and poor recognition accuracy may exist.

### SUMMARY

Embodiments of this application provide a method and apparatus for training an image recognition model, a device, and a medium, capable of improving accuracy of image recognition and improve a screening negative rate of a medical pathological image. The technical solutions are as follows.

According to one aspect, a method for training an image recognition model is performed by a computer device. The method includes:
obtaining a sample image and a corresponding sample label;
obtaining a sample image patch bag of sample image patches corresponding to the sample image, the sample patch bag having a bag label corresponding to the sample label of the sample image;
performing feature analysis on the sample patch bag and the sample image patches in the sample patch bag, respectively, by using an image recognition model;
determining a relative entropy loss and a first cross entropy loss corresponding to the sample patch bag based on a difference between the bag label and a corresponding bag feature analysis result and a second cross entropy loss corresponding to the sample image patches based on a difference between the sample label and a corresponding patch analysis result, respectively; and
training the image recognition model based on the relative entropy loss, the first cross entropy loss, and the second cross entropy loss, the trained image recognition model being configured to recognize image content in an image.

According to another aspect, a computer device is provided. The computer device includes a processor and a memory. The memory has at least one instruction, at least one program, a code set, or an instruction set stored therein, and the at least one instruction, the at least one program, the code set, or the instruction set is loaded and executed by the processor and causes the computer device to implement the method for training an image recognition model according to any one of the embodiments of this application.

According to another aspect, a non-transitory computer-readable storage medium is provided. The storage medium has at least one instruction, at least one program, a code set, or an instruction set stored thereon, and the at least one instruction, the at least one program, the code set, or the instruction set is loaded and executed by a processor of a computer device and causes the computer device to implement the method for training an image recognition model according to any one of the embodiments of this application.

The technical solutions provided in the embodiments of this application have at least the following beneficial effects:

During a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a lesion in a pathological image, to improve efficiency and accuracy of lesion recognition.

### BRIEF DESCRIPTION OF THE DRAWINGS

FIG. 1 is a schematic diagram of a process for training an image recognition model according to an exemplary embodiment of this application.

FIG. 2 is a schematic diagram of an implementation environment according to an exemplary embodiment of this application.

FIG. 3 is a flowchart of a method for training an image recognition model according to an exemplary embodiment of this application.

FIG. 4 is a schematic diagram of a process of extracting patches from an image according to the embodiment as shown in FIG. 3.

FIG. 5 is a flowchart of a method for training an image recognition model according to another exemplary embodiment of this application.

FIG. 6 is a schematic diagram of a feature extraction process according to the embodiment as shown in FIG. 5.

FIG. 7 is a schematic diagram of another feature extraction process according to the embodiment as shown in FIG. 5.

FIG. 8 is a schematic diagram of still another feature extraction process according to the embodiment as shown in FIG. 5.

FIG. 9 is a schematic diagram of an overall training process according to an exemplary embodiment of this application.

FIG. 10 is a flowchart of a method for training an image recognition model according to still another exemplary embodiment of this application.

FIG. 11 is a flowchart of an image recognition method according to an exemplary embodiment of this application.

FIG. 12 is a schematic diagram of a model training effect according to an exemplary embodiment of this application.

FIG. 13 is a structural block diagram of an apparatus for training an image recognition model according to an exemplary embodiment of this application.

FIG. 14 is a structural block diagram of an apparatus for training an image recognition model according to another exemplary embodiment of this application.

FIG. 15 is a structural block diagram of a computer device according to an exemplary embodiment of this application.

### DESCRIPTION OF EMBODIMENTS

Artificial intelligence (AI): It is a theory, method, technology, and an application system that use a digital computer or a machine controlled by a digital computer to simulate, extend, and expand human intelligence, perceive an environment, acquire knowledge, and use knowledge to obtain an optimal result.

Machine learning (ML): It is a multi-field interdiscipline, and relates to a plurality of disciplines such as the probability theory, statistics, approximation theory, convex analysis, and algorithm complexity theory.

An image recognition technology may be applied to a plurality of fields, such as: a traffic image recognition field, a medical auxiliary diagnosis field, and a home video recognition field.

First, in this embodiment, the medical auxiliary diagnosis field is used as an example for description.

Histopathology is an important part of modern medicine and plays an important role in a cancer diagnosis, etiology analysis, a survival rate prediction, and formulations of personalized treatment plans. Histopathology is a process of obtaining biopsy tissue patches, obtaining fixed tissue patches using paraffin embedding, extracting patches from tissue blocks and coloring the tissue blocks, and the like, and finally using a high-precision scanner to scan the tissue blocks to obtain a high-resolution digital pathology whole slide image. The digital pathology whole slide image includes a large amount of phenotypic information, and a doctor can make a diagnosis by viewing the digital pathology whole slide image (a pathological image for short). However, due to a large size and many details of the pathological image, there are problems such as easy omission of details and low diagnostic efficiency.

With the development of computer hardware and deep learning algorithms, artificial intelligence brings revolutionary changes to many fields. In the medical industry, an AI-assisted diagnosis becomes a new trend. With AI assistance, a pathological image can be automatically analyzed, and a diagnostic report can be automatically generated, which can be further confirmed by a doctor. This new diagnostic method for AI-assistance not only improves efficiency of the doctor, but also improves accuracy of a diagnosis.

When an image recognition model is used to recognize a pathological lesion in a pathological image, if the entire pathological image is used as input, problems such as long prediction time and difficulty in convergence occur due to large pathological image data and a weak supervision signal. Therefore, in related arts, patches are extracted from the pathological image, and a local patch is used as input, and the image recognition model performs recognition and a prediction on the local patch, to combine recognition results of all local patches to obtain a final lesion recognition result of the pathological image, that is, multiple instance learning (MIL).

However, based on characteristics of multiple instance learning, because only one instance needs to be determined as a lesion, the entire pathological image is recognized as a lesion, and all instances need to be determined as non-lesions to determine that the entire pathological image is not a lesion. Therefore, in pathological image recognition, it is more likely to recognize a sample as a lesion. Therefore, there is a problem of low screening negative rate.

For the foregoing problems, embodiments of this application provide a weakly supervised method for training an image recognition model using local annotation. In the embodiments of this application, on the basis of weak supervision, a small quantity of patch-level/pixel-level labels are used for training the image recognition model. This improves recognition accuracy of the image recognition model. Therefore, a situation of the low screening negative rate is reduced.

The foregoing pathological image data and other image data are data actively uploaded by a user; or data obtained with separate authorization from the user. In the embodiments, pathological image recognition is used as an example for description. The method for training an image recognition model according to the embodiments of this application may also be applied to another scenario. This is not limited.

Information (which includes but not limited to user device information, user personal information, and the like), data (which includes but not limited to data used for analysis, stored data, displayed data, and the like), and signals involved in this application are all separately authorized by the user or fully authorized by all parties, and collection, use, and processing of related data need to comply with relevant laws, regulations, and standards of relevant regions. For example, the pathological image data in this application is acquired under full authorization.

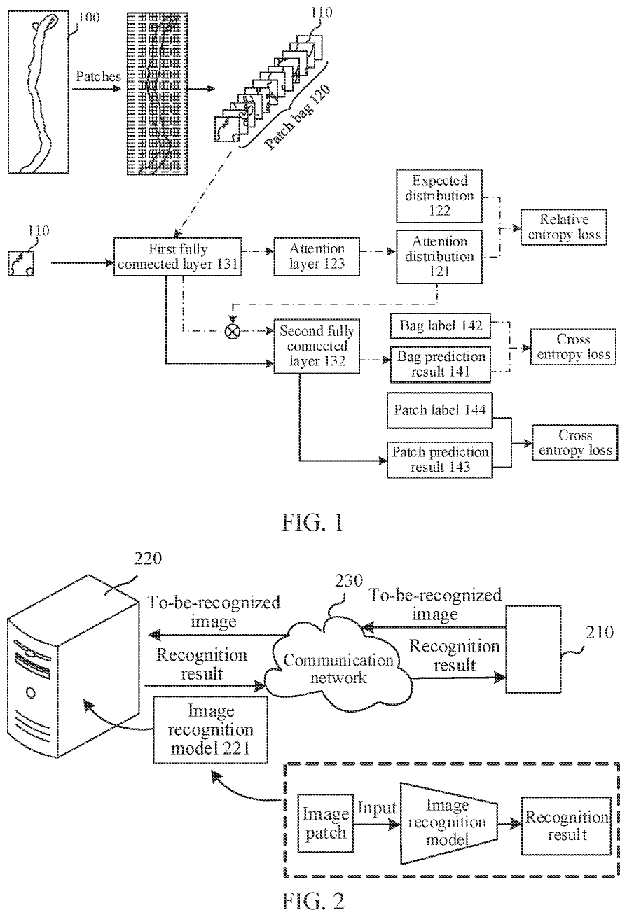

Embodiments of this application provide a weakly supervised method for training an image recognition model using local annotation. FIG. 1 is a schematic diagram of a process for training an image recognition model according to an exemplary embodiment of this application. As shown in FIG. 1, after a pathological image 100 is obtained, image patches 110 are extracted from the pathological image 100, and a patch bag 120 is constituted of the image patches 110.

For the patch bag 120, the following two parts of loss obtaining are included.

### 1. Relative Entropy Loss

The patch bag 120 is inputted into a first fully connected layer 131 of the image recognition model, and a bag feature of the patch bag 120 and patch features of the patches in the patch bag 120 are outputted. Then, an attention distribution 121 of the patch bag 120 is classified and predicted by an attention layer 123 according to the bag feature and the patch features. The relative entropy loss is determined based on a difference between an expected distribution 122 corresponding to a bag label labeled by the patch bag 120 and the foregoing predicted attention distribution 121.

### 2. Cross Entropy Loss

After the patch bag 120 is inputted to the first fully connected layer 131, output of the first fully connected layer 131 and a fused feature of the attention distribution 121 are used as input, and input to a second fully connected layer 132. Feature processing is performed on the fused feature by the second fully connected layer 132 to obtain a bag prediction result 141. A cross entropy loss of the patch bag 120 is determined based on the bag prediction result 141 and a bag label 142.

For the image patches 110, the following loss obtaining is included.

### Cross Entropy Loss:

After the image patches 110 are inputted to the foregoing first fully connected layer 131, the output of the first fully connected layer 131 is used as input, and feature processing is performed by the second fully connected layer 132 to obtain a patch prediction result 143. A cross entropy loss of the image patches 110 is determined based on the patch prediction result 143 and a patch label 144.

The image recognition model is trained based on the relative entropy loss and cross entropy loss of the patch bag 120 and the cross entropy loss of the image patches 110.

Next, an implementation environment of embodiments of this application is described. For example, refer to FIG. 2. The implementation environment includes a terminal 210 and a server 220. The terminal 210 and the server 220 are connected via a communication network 230.

In some embodiments, the terminal 210 is configured to send image data to the server 220. In some embodiments, an application program with an image recognition function is installed in the terminal 210. For example, an application with an auxiliary diagnosis function is installed in the terminal 210. For example, a search engine program, a life assistance application, an instant messaging application, a video program, and a game program are installed in the terminal 210. This is not limited in the embodiments of this application.

An image recognition model 221 is installed in the server 220. The image recognition model 221 can recognize a large amount of pathological image data, and when a pathological image is recognized, a plurality of image patches are first extracted from the pathological image, and then the plurality of image patches are recognized to obtain recognition results, then the recognition results of the plurality of image patches are combined to obtain a recognition result corresponding to the pathological image.

During a training process of the image recognition model 221, the image recognition model 221 is trained by the following steps: extracting patches from a sample image and constituting the patches into a patch bag; calculating a relative entropy loss and a cross entropy loss by the patch bag; and calculating a cross entropy loss is by the image patches.

The foregoing terminal may be a mobile phone, a tablet computer, a desktop computer, a portable laptop, a smart TV, an on-board terminal, a smart home device, and other forms of terminal devices. This is not limited in the embodiments of this application.

The server may be an independent physical server, or a server cluster or distributed system including a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), big data, and an artificial intelligence platform.

Cloud technology refers to a hosting technology that integrates resources, such as hardware, software, and a network, to implement data computing, storage, processing, and sharing in a wide area network or local area network. In some embodiments, the foregoing server may alternatively be implemented as a node in a blockchain system.

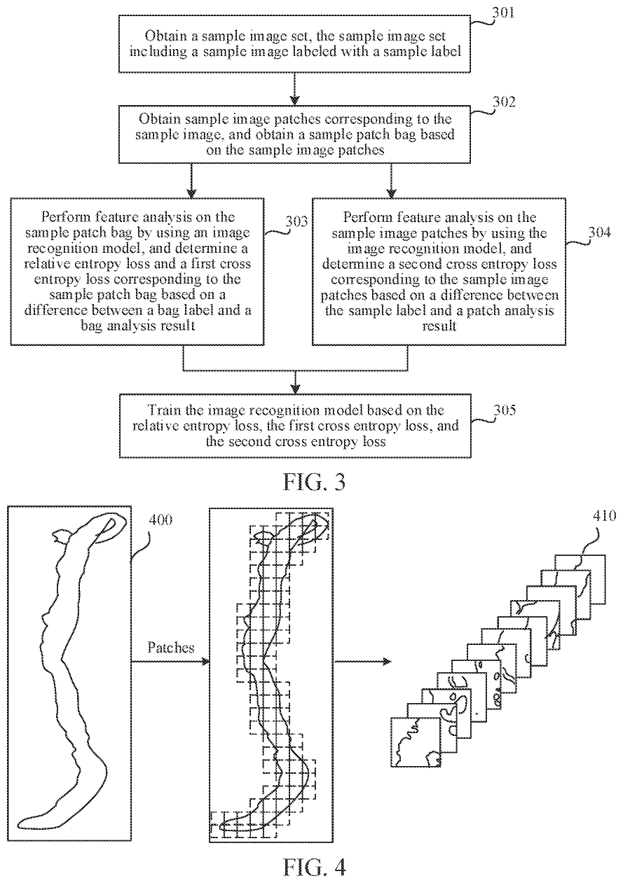

In combination with the term introduction and the application scenario above, the following describes a method for training an image recognition model. The method may be performed by a server or a terminal, or may be performed by a server and a terminal together. In this embodiment of this application, an example in which the method is performed by a server is described. As shown in FIG. 3, the method includes the following steps.

Step 301: Obtain a sample image set, the sample image set including a sample image labeled with a sample label.

The sample label indicates an inclusion of image content in the sample image.

For example, when the sample image is implemented as a pathological image, the sample label indicates an inclusion of a lesion part in the pathological image, and when the pathological image includes a lesion part, the sample label also indicates an image region where the lesion part is located in the pathological image.

When the sample image is implemented as a traffic acquisition image, the sample label indicates an inclusion of a transportation in the traffic acquisition image, and when the traffic acquisition image includes a transportation, the sample label also indicates an identifier of the transportation in the traffic acquisition image, such as a license plate number of a vehicle in the traffic acquisition image. The traffic acquisition image refers to an image acquired by a traffic camera device.

When hen the sample image is implemented as a home video image, the sample label indicates an inclusion of a creature in the home video image, and when the home video image includes a creature, the sample label also indicates a type of the creature in the home video image, for example, the home video image includes a pet (a cat).

In some embodiments, image types of the sample images in the sample image set are the same, for example, the sample images are all pathological images. Alternatively, image types of the sample images in the sample image set are different, for example, some of the sample images are pathological images, and some of the sample images are traffic acquisition images.

In some embodiments, the sample image set is an image set obtained from a public data set, or the sample image set is an image set including image data authorized and uploaded by a user. This is not limited in this embodiment.

The sample label labeled on the sample image may be labeled in the following manners. After a sample acquisition personnel acquires the sample image, the personnel distinguishes image content in the sample image and labels the sample image. For example, when the sample image is implemented as a pathological image, an image diagnosed and labeled by a doctor is obtained, the pathological image is labeled based on a diagnosis result of the doctor, and when the pathological image is positive, in other words, there is a lesion region in the pathological image, the lesion region is labeled based on the diagnosis of the doctor. Alternatively, the sample image is inputted to a pre-trained recognition model, and a prediction result is outputted as a sample label. In this case, the sample label is implemented as a pseudo label.

To be specific, taking a pathological image as an example, when the pathological image is negative, in other words, there is no lesion region in the pathological image, an overall label of the pathological image is labeled as “negative”. When the pathological image is positive, in other words, there is a lesion region in the pathological image, an overall label of the pathological image is labeled as “positive”, and an image region in the pathological image that includes the lesion region is labeled.

Step 302: Obtain sample image patches corresponding to the sample image, and obtain a sample patch bag based on the sample image patches.

The sample patch bag is labeled with a bag label corresponding to the sample label, and the sample image patches are obtained by segmenting an image region of the sample image.

Taking a pathological image as an example, patches are extracted from the pathological image and a local patch is inferred, and inference results of all local patches are combined to obtain a final inference result of the entire pathological image. Multi-instance learning regards a patch as an instance and a pathological image as a bag, in other words, a bag includes a plurality of instances. If there is an instance determined as positive, the entire bag is positive. On the contrary, if all instances are determined as negative, the bag is negative. In this embodiment of this application, all instances included in the bag come from the same pathological image, or from different pathological images.

In some embodiments, that the segmenting an image region of the sample image includes at least one of the following manners.

First, the entire sample image is segmented into equal sizes to obtain sample image patches with consistent image sizes. For a sample image patch at an edge position, an edge with an insufficient size is filled in the form of blanks, so that an edge sample patch that is consistent in size with other sample patches is obtained.

For example, FIG. 4 is a schematic diagram of a process of extracting patches from an image according to an exemplary embodiment of this application. As shown in FIG. 4, a sample image 400 is segmented into equal sizes, and edge positions are filled with blanks, so that sample image patches 410 corresponding to the sample image 400 are obtained.

Second, a middle region of the sample image is segmented into equal sizes to obtain sample image patches with consistent image sizes. Sample image patches within a sample image range and satisfy the image size are cropped starting from an edge position of the sample image, and image parts not acquired are discarded.

Third, a minimum rectangular range including the sample image is determined as a sample extended image. The sample extended image is segmented into equal sizes to obtain candidate sample patches, and candidate sample patches that do not have image content in the candidate sample patches are discarded, and retained candidate sample patches are sample image patches.

The foregoing manners of segmenting the sample patches is only a schematic example, and the manners of obtaining sample patches are not limited in this embodiment of this application.

In some embodiments, after the sample image is segmented into the sample image patches, and the sample patch bag is constituted, at least one of the following cases is included.

(1) Sample image patches belonging to the same sample image are summarized into the same sample patch bag, and sample patch bags respectively corresponding to each sample image are obtained.

The sample label labeled on the sample image is a bag label corresponding to the sample patch bag. For example, if the sample image is labeled as “negative”, the sample patch bag is also labeled as “negative”; if the sample image is labeled as “positive”, the sample patch bag is also labeled as “positive”. An inclusion of image content in each sample image patch obtained by segmenting the sample image is determined correspondingly according to a region where labeled image content in the sample image is located, and patch labels are labeled for the sample image patches. For example, if the sample image is labeled with a region where an image is located as region 1 in the sample image, when a sample image patch a includes the entire or a part of the region 1, it is considered that the sample image patch a includes image content.

In some embodiments, if the sample label of the sample image indicates that image content is not included in the sample image, the sample patch bag only needs the bag label used for indicating that the image content is not included in the sample patch bag, without further labeling the patch label for the sample image patches.

When the sample image patch includes the image content, the patch label of the sample image patch may be category-level or pixel-level. When the patch label is category-level, in other words, the patch label indicates whether the sample image patch includes the image content. For example, “positive” or “negative” is labeled for a sample image patch of a pathological image. In one embodiment, if the sample image patch includes image content, the patch label is “P”, that is, positive; if the sample image patch does not include image content, the patch label is “N”, that is, negative. If the patch label is pixel-level, the patch label indicates a position of image content in the sample image patch. For example, the image content fills the sample image patch, or the image content is located in a region 2 of the sample image patch. In some embodiments, the pixel-level label may also indicate a pixel proportion of the image content in the sample image patch, for example, a proportion of a quantity of pixels in the region 2 to a total quantity of pixels in the sample image patch.

(2) After each sample image is segmented into sample image patches, a patch set of the sample image patches is obtained, n sample image patches are randomly obtained from the patch set to constitute a sample patch bag, and n is a preset positive integer.

In other words, sample image patches in the same sample patch bag come from the same or different sample images.

Then a bag label of the sample patch bag is determined based on patch labels corresponding to the sample image patches. Alternatively, a bag label of the sample patch bag is determined based on a sample label of a source sample image of the sample image patches. For example, if the sample label of the sample image from which the sample image patches come indicates that there is no image content, the sample image patches do not include the image content, and the bag label of the sample patch bag indicates that the image content is not included.

If the sample image from which the sample image patches come includes the image content, the bag label of the sample patch bag needs to be determined based on the patch labels. Taking a pathological image as an example, to be specific, if patch labels of all sample image patches are “negative”, a bag label of a patch bag is “negative”; if patch labels of the sample image patches in a patch bag are “positive”, then a bag label of the patch bag is “positive”.

Because there is a label for the sample image, and the label indicates an inclusion of image content in the sample image, after a region of the sample image is segmented, the patch labels of the sample image patches are determined based on the sample label of the sample image. For example, taking a pathological image as an example, if a sample label of a sample image is “negative”, patch labels of all sample image patches are “negative”; if a sample label of a sample image is “positive”, whether the sample image patches are “negative” or “positive” is determined based on a position of an image region labeled on the sample image.

(1) Sample image patches belonging to the same sample image are summarized into the same sample patch bag, and n sample image patches are randomly obtained from a patch set to constitute a sample patch bag. In other words, the sample patch bag includes both sample image patches obtained by segmenting the same sample image, and sample image patches obtained by segmenting different sample images.

Step 303: Perform feature analysis on the sample patch bag by using an image recognition model, and determine, based on a difference between the bag label and a bag analysis result, a relative entropy loss and a first cross entropy loss corresponding to the sample patch bag.

In some embodiments, an attention distribution is predicted based on the image content in the sample patch bag, and an expected distribution corresponding to the bag label of the sample patch bag is determined. The relative entropy loss is a loss determined based on a difference between the attention distribution and the expected distribution. In other words, after feature extraction is performed on the sample patch bag by using the image recognition model, a distribution of the extracted feature is analyzed, so that the attention distribution of the image content in the sample patch bag is obtained, and the sample patch bag is labeled with a bag label. The bag label indicates the expected distribution corresponding to the sample patch bag. Then the relative entropy loss of the sample patch bag is determined based on the difference between the attention distribution and the expected distribution. In other words, feature extraction is performed on the sample patch bag by using the image recognition model to obtain a bag feature, and the relative entropy loss corresponding to the sample patch bag is determined based on the attention distribution corresponding to the bag feature and the expected distribution corresponding to the bag label.

In some embodiments, a prediction result is obtained based on analysis of the image content in the sample patch bag, and the first cross entropy loss is a loss determined based on a difference between the prediction result and the bag label of the sample patch bag. In other words, after feature extraction is performed on the sample patch bag by using the image recognition model, image content of the extracted feature is analyzed, so that a predicted inclusion of the image content in the patch bag is obtained, and the first cross entropy loss of the sample patch bag is determined based on a difference between the predicted inclusion and an inclusion represented by the bag label. In other words, the first cross entropy loss corresponding to the sample patch bag is determined based on a difference between a recognition result of image content recognition of the bag feature and the bag label.

After the sample patch bag is obtained, the relative entropy loss and the first cross entropy loss corresponding to the sample patch bag are determined based on the bag feature and the bag label. The relative entropy loss may be used to better measure an amount of information lost between the attention distribution corresponding to the bag feature and the expected distribution corresponding to the bag label. The first cross entropy loss may be used to better determine closeness between an actual output recognition result and an expected output bag label. The relative entropy loss represented the loss of information and the first cross entropy loss represented the closeness are combined to implement more comprehensive analysis of the constituted sample patch bag.

Step 304: Perform feature analysis on the sample image patches by using the image recognition model, and determine, based on a difference between the sample label and a patch analysis result, a second cross entropy loss corresponding to the sample image patches.

In some embodiments, a prediction result is obtained based on analysis of the image content in the sample image patches, and the second cross entropy loss is a loss determined based on a difference between the prediction result and the patch labels of the sample image patches. The patch label may be a sample label of the sample image, or may be a patch label inferred based on the sample label.

In other words, after feature extraction is performed on the sample image patch by using the image recognition model, image content of the extracted feature is analyzed, so that an inclusion of the image content in the image patch is obtained, and the second cross entropy loss of the sample image patch is determined based on a difference between the predicted inclusion and an inclusion represented by the patch label.

Step 303 and step 304 are two parallel steps. Step 303 may be performed first and then step 304, step 304 may be performed first and then step 303, or step 303 and step 304 may be performed at the same time. This is not limited in this embodiment.

Step 305: Train the image recognition model based on the relative entropy loss, the first cross entropy loss, and the second cross entropy loss.

In some embodiments, the relative entropy loss, the first cross entropy loss, and the second cross entropy loss are fused to obtain a total loss, so that the image recognition model is trained based on the total loss.

In one embodiment, when the relative entropy loss, the first cross entropy loss, and the second cross entropy loss are fused, the relative entropy loss, the first cross entropy loss, and the second cross entropy loss are weighted and fused using respective weights. A weighted sum of the relative entropy loss, the first cross entropy loss, and the second cross entropy loss is calculated to obtain a total loss value.

When the total loss value for training the image recognition model is determined, proportions of different losses in the total loss value can be adjusted with the help of weights that represent relative importance of different losses in the total loss value, to obtain a total loss that can better reflect an overall feature of a sample image patch bag. While impacts of different losses are comprehensively considered, a more accurate total loss value is obtained as much as possible to implement a more robust training for the image recognition model.

In one embodiment, when the image recognition model is trained based on the total loss value, a model parameter of the image recognition model is adjusted based on a gradient descent method.

In this embodiment, an initial learning rate of 1e-3 is used, and a change of the learning rate is controlled by a cosine annealing policy. In addition, an Adam optimizer is used to adjust the model parameter using the gradient descent method to make a model parameter training effect of the image recognition model converge.

In one embodiment, when the model parameter of the image recognition model is adjusted, parameters in a first fully connected layer and a second fully connected layer in the image recognition model are adjusted according to the total loss value. In one embodiment, parameters in another network layer in the image recognition model may alternatively be adjusted based on the total loss value.

In conclusion, according to the method in this embodiment, during a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a pathological lesion in a pathological image, to improve efficiency and accuracy of lesion recognition.

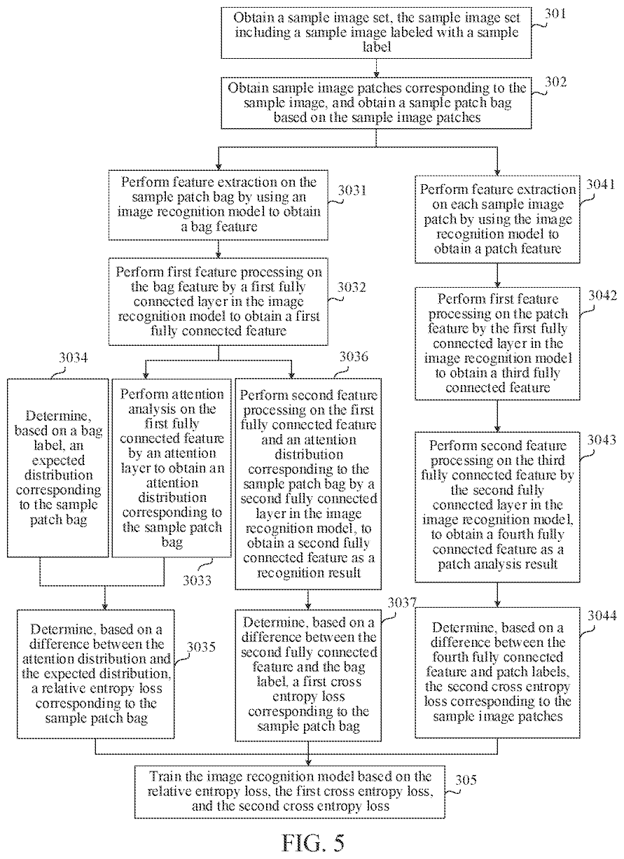

In an embodiment, the image recognition model includes a first fully connected layer and a second fully connected layer. The foregoing relative entropy loss and cross entropy loss are determined based on the fully connected layer. FIG. 5 is a flowchart of a method for training an image recognition model according to another exemplary embodiment of this application. The method may be performed by a server or a terminal, or may be performed by a server and a terminal together. In this embodiment of this application, an example in which the method is performed by a server is described. As shown in FIG. 5, steps 303 and 304 may be implemented as the following steps.

Step 3031: Perform feature extraction on the sample patch bag by using an image recognition model to obtain a bag feature.

In some embodiments, feature extraction is performed on the sample patch bag by a feature extraction layer in the image recognition model to obtain the bag feature. In one embodiment, feature extraction is performed on each sample image patch in the sample patch bag by the feature extraction layer to obtain a patch feature, so that the bag feature constituted of patch features is determined, and the bag feature is a set of the patch features.

In this embodiment, an example in which the feature extraction layer is implemented as a component of the image recognition model is used for description. In some embodiments, the feature extraction layer may alternatively be implemented as an independent feature extraction network. This is not limited in this embodiment.

In some embodiments, the feature extraction layer upsamples/downsamples each sample image patch in the sample patch bag via a convolution operation to obtain the patch feature, and the bag feature is constituted based on integration of the patch features.

Step 3032: Perform first feature processing on the bag feature by a first fully connected layer in the image recognition model to obtain a first fully connected feature.

The image recognition model includes the first fully connected layer. Each node in a fully connected layer is connected to all nodes in a previous layer to combine the foregoing extracted features. A fully connected layer (FC) plays a role of “classifier” in a convolutional neural network.

The bag feature is inputted to the first fully connected layer, and the bag feature is classified by the first fully connected layer, to output the first fully connected feature. The first fully connected feature represents relationships between the bag feature and each classification item after recognition by the first fully connected layer. For example, if the classification item includes both positive and negative items, the first fully connected feature represents preliminary recognition results of the bag feature corresponding to a positive classification and a negative classification after processing by the first fully connected layer. In some embodiments, the fully connected layer is used for initially screening a feature belonging to a positive classification and a feature belonging to a negative classification from the bag feature.

Step 3033: Perform attention analysis on the first fully connected feature by an attention layer to obtain an attention distribution corresponding to the sample patch bag.

An attention mechanism originates from a study of human vision. In cognitive science, due to an information processing bottleneck, a human being selectively focuses on a part of all information while ignoring other visible information. The foregoing mechanism is often referred to as an attention mechanism. Different parts of a retina of a human being have different levels of information processing capabilities, that is, acuity, and only a fovea has the strongest acuity. To properly utilize limited visual information processing resources, a human being needs to select a specific part of a visual region and then focus on the part.

To be specific, the foregoing attention layer applies the attention mechanism to selectively focus on a feature belonging to the positive classification or the negative classification in the first fully connected feature, so that the attention distribution corresponding to the sample patch bag is obtained.

In some embodiments, output of the attention layer is classified and predicted to obtain an attention distribution of the first fully connected feature corresponding to a classification item.

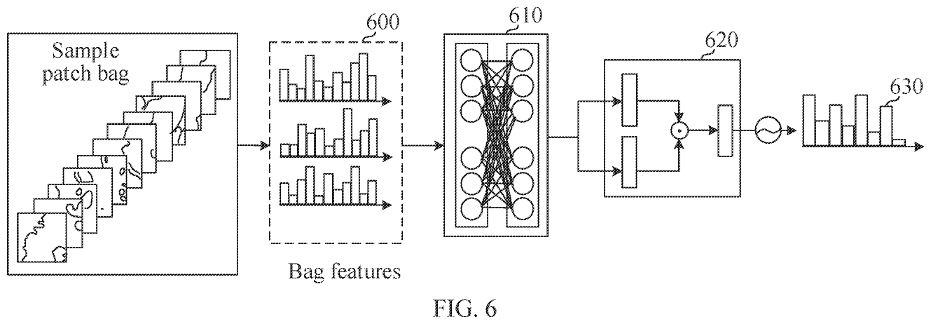

For example, as shown in FIG. 6, after bag features 600 corresponding to the sample patch bag are obtained, the bag features 600 are inputted to a first fully connected layer 610, and output of the first fully connected layer 610 is used as input, attention analysis is performed by an attention layer 620, and output of the attention layer 620 is classified and predicted to obtain an attention distribution 630 corresponding to the sample patch bag.

Step 3034: Determine, based on the bag label, an expected distribution corresponding to the sample patch bag.

A manner of obtaining the bag label is described in step 302. Details are not described herein again.

In some embodiments, when the expected distribution corresponding to the sample patch bag is determined based on the bag label, at least one of the following cases is included.

1. The expected distribution of the sample patch bag is determined, in response to the bag label indicating that the image content does not exist in the sample image patches in the sample patch bag, as a uniform distribution.

The bag label indicates that the sample image patches in the sample patch bag do not have the image content. An example in which the sample image is used as a pathological image, the bag label indicates that the sample patch bag is negative. Then the expected distribution corresponding to the sample patch bag is the uniform distribution.

Because the bag label indicates that no image content exists in the sample patch bag, that any sample image patch in the sample patch bag does not include the image content can be obtained. Therefore, in this case, no patch-level patch label is needed to determine the expected distribution corresponding to the sample patch bag.

2. A patch label corresponding to the sample image patches is obtained in the bag label in response to the bag label indicating that the image content exists in the sample image patches in the sample patch bag, and the expected distribution of the sample patch bag is determined based on the patch labels.

The sample patch bag has a patch-level label, in other words, the sample image patches in the sample patch bag include patch labels. The patch labels indicate an inclusion of the image content in the sample image patches, and the patch labels are determined based on a sample label of the sample image. The specific determining method is described in step 302 and is not described herein again.

The patch-level label of the sample patch bag also includes at least one of the following cases.

2.1. The expected distribution of the sample patch bag is determined, in response to the patch labels including classification labels, based on classification labels corresponding to the sample image patches, each classification label has a corresponding expected distribution of an instance.

The patch-level label is a classification label, in other words, the patch labels of the sample image patches indicate whether the sample image patches include the image content, but does not specifically indicate a specific position of the image content. Then in the expected distribution corresponding to the sample patch bag: An expected distribution corresponding to a sample image patch with image content is 1/p. p represents a total quantity of sample image patches with the image content in the sample patch bag. An expected distribution corresponding to a sample image patch without image content is zero.

An example in which a pathological image is used for description, an expected distribution corresponding to a sample image patch with a positive patch label is 1/p, and an expected distribution corresponding to a sample image patch with a negative patch label is zero, so that an expected distribution corresponding to an entire sample patch bag is obtained.

2.2. The expected distribution of the sample patch bag is determined, in response to the patch labels including the pixel distribution labels, based on distributions labeled by the pixel distribution labels each pixel distribution label is used for regionally labeling pixel content in the sample image patches.

The patch-level label is a pixel-level label, in other words, the patch labels of the sample image patches indicate whether the sample image patches include the image content, if the sample image patches include the image content, the patch labels also indicate a pixel position of the image content in the sample image patches. Then in the expected distribution corresponding to the sample patch bag: An expected distribution corresponding to all sample image patches is a proportion of pixels corresponding to the image content to the total pixels, and the expected distribution of all sample image patches is normalized to obtain the expected distribution of the sample patch bag. The proportion of pixels corresponding to the image content to the total pixels refers to a proportion of the pixels corresponding to the image content in the sample image patches to the total pixels of the sample image patches. Results are different for different sample image patch proportions, for example, a proportion of some sample image patches is 100%, and a proportion of some sample image patches is 0% (where a patch label is negative). When proportions of all sample image patches are normalized, the proportions of all image patches may be averaged, and the average of the proportions of all sample image patches in the sample patch bag is used as the expected distribution of the sample patch bag.

In this embodiment, labeling levels of patch labels corresponding to sample image patches in the same sample patch bag are the same. In other words, patch labels corresponding to sample image patches in the same sample patch bag are all classification labels. Alternatively, patch labels corresponding to sample image patches in the same sample patch bag are all pixel-level labels.

A specific distribution state of the expected distribution is determined according to an inclusion of image content represented by the bag label in the sample image patches in the sample patch bag, so that a distribution result of the expected distribution can be more accurately determined based on an analysis result of the inclusion. If the image content exists in the sample image patches, the expected distribution is a uniform distribution to more intuitively represent that patch label states of the sample image patches in the sample patch bag are uniform. If the image content exists in the sample image patches, it means that the patch label states of the sample image patches in the sample patch bag may be different. From this, deeper analysis of the expected distribution can be performed based on the patch labels, to obtain a more realistic reflection of the expected distribution of the sample image patches in the sample patch bag from a plurality of angles, so that accuracy of the relative entropy loss determined based on the expected distribution is improved.

In addition, when the expected distribution of the sample patch bag is determined based on the patch label, a label type of the patch label is first determined, and then a distribution indicated by a corresponding label type is used for determining the expected distribution corresponding to the sample patch bag. The expected distribution of the sample patch bag can be determined more flexibly based on a difference between a classification label and a pixel distribution label.

Step 3035: Determine, based on a difference between the attention distribution and the expected distribution, the relative entropy loss corresponding to the sample patch bag.

In one embodiment, after the attention distribution and the expected distribution are determined, the difference between the attention distribution and the expected distribution is determined, so that the relative entropy loss corresponding to the sample patch bag is obtained. The relative entropy loss is calculated as shown in formula 1 below.

$${ℒ}_{kld} ( w , \tilde{{w}_{l}} ) = - {\sum }_{i} \tilde{{w}_{l}} log ( \frac{{e}^{{w}_{i}}}{{\sum }_{j} {w}_{j}} ) + {\sum }_{i} {\tilde{w}}_{l} log \tilde{{w}_{l}} \qquad Formula 1$$

w represents a weight distribution of an attention output by a network after being transformed by a classification layer, and [symbol] represents a given standard distribution. i represents an i^{th} sample image patch in the sample patch bag, and j represents a total quantity of sample image patches in the sample patch bag.

In steps 3032 to 3035, the determining of the attention distribution and the expected distribution corresponding to the sample patch bag is described, so that the relative entropy loss of the sample patch bag is determined. During feature processing and attention analysis processes of the image recognition model, a deep exploration of an image region of focus is performed on the basis of avoiding an interference of redundant information, to determine a more targeted attention distribution. In addition, an expected distribution that better represents an integrity is determined based on the inclusion of the image content in the sample image patches in the sample patch bag, so that a more accurate relative entropy loss can be obtained based on the difference between the attention distribution and the expected distribution.

Step 3036: Perform second feature processing on the first fully connected feature and an attention distribution corresponding to the sample patch bag by a second fully connected layer in the image recognition model, to obtain a second fully connected feature as a recognition result.

The foregoing content is a process of determining a loss value based on the attention distribution of the sample patch bag. In addition, this embodiment of this application also includes a process of determining a cross entropy loss value based on a recognition result of the image content in the sample patch bag.

In some embodiments, feature fusion is performed on the foregoing first fully connected feature and the attention distribution corresponding to the sample patch bag, and a fused feature is inputted to the second fully connected layer. In some embodiments, the first fully connected feature and the attention distribution are weighted and summed, and a weighted summation result is inputted to the second fully connected layer for a probability prediction. In one embodiment, a value calculated via a classification function based on output of the second fully connected layer is used as a prediction probability of a corresponding category of the sample patch bag.

For example, an example in which a pathological image is used, after the fused feature of the first fully connected feature and the attention distribution is inputted to the second fully connected layer, a corresponding positive probability and a corresponding negative probability of the sample patch bag are outputted as the second fully connected feature, so that a classification with a high probability is used as a recognition result corresponding to the sample patch bag.

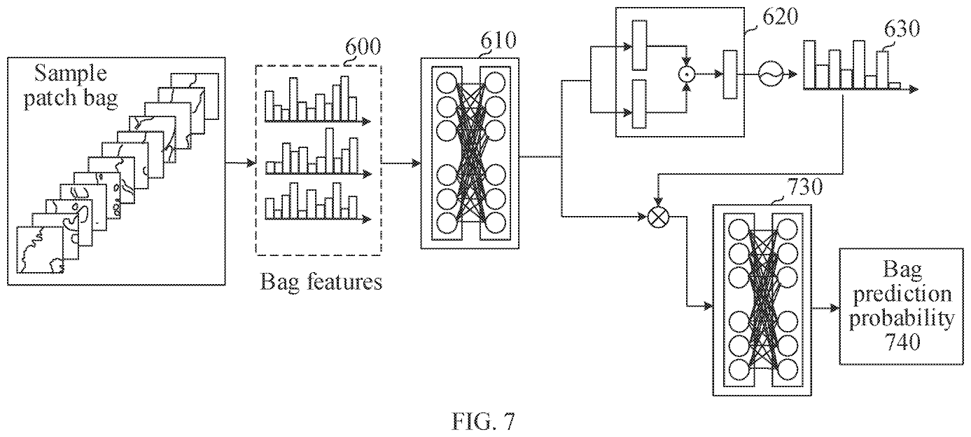

For example, as shown in FIG. 7, after bag features 600 corresponding to the sample patch bag are obtained, the bag features 600 are inputted to a first fully connected layer 610, and output of the first fully connected layer 610 and an attention distribution feature 630 are used as input, feature analysis is performed by a second fully connected layer 730, so that a bag prediction probability 740 is outputted.

Step 3037: Determine, based on a difference between the second fully connected feature and the bag label, the first cross entropy loss corresponding to the sample patch bag.

In one embodiment, the first cross entropy loss corresponding to the sample patch bag is determined by using formula 2 below.

$${ℒ}_{c e} ( p , φ ( B ) ) = - {\sum }_{i} φ ( B , i ) log ( {p}_{i} ) \qquad Formula 2$$

p represents a predicted probability, φ(B) represents a pre-labeled bag label, and i represents an i^{th} sample patch bag.

In steps 3036 and 3037, the obtaining the first cross entropy loss based on the second fully connected feature and the bag label is described. When the recognition result is obtained based on the second fully connected layer in the image recognition model, the bag feature outputted by the first fully connected layer and the attention distribution corresponding to the sample patch bag are combined, and a deep exploration of a region of focus indicated by the attention distribution is performed on the basis of analyzing the entire sample patch bag. This makes the second fully connected feature more accurate after feature processing, and improves accuracy of the first cross entropy loss when the first cross entropy loss based is calculated on the bag label.

Step 3041: Perform feature extraction on each sample image patch by using the image recognition model to obtain a patch feature.

In some embodiments, the feature extraction is performed on each sample image patch by a feature extraction layer in the image recognition model to obtain the patch feature.

In this embodiment, an example in which the feature extraction layer is implemented as a component of the image recognition model is used for description. In some embodiments, the feature extraction layer may alternatively be implemented as an independent feature extraction network. This is not limited in this embodiment.

In some embodiments, the feature extraction layer upsamples/downsamples each sample image patch via a convolution operation to obtain the patch feature.

Step 3042: Perform first feature processing on the patch feature by the first fully connected layer in the image recognition model to obtain a third fully connected feature.

The image recognition model includes the first fully connected layer, the patch feature is inputted to the first fully connected layer, and the patch feature is classified by the first fully connected layer, to output the third fully connected feature. The third fully connected feature represents relationships between the patch feature and each classification item after recognition by the first fully connected layer. For example, if the classification item includes both positive and negative items, the third fully connected feature represents preliminary recognition results of the patch feature corresponding to a positive classification and a negative classification after processing by the first fully connected layer. In some embodiments, the fully connected layer is used for initially screening a feature belonging to a positive classification and a feature belonging to a negative classification from the patch feature.

Step 3043: Perform second feature processing on the third fully connected feature by the second fully connected layer in the image recognition model, to obtain a fourth fully connected feature as a patch analysis result.

In some embodiments, the third fully connected feature is inputted to the second fully connected layer, a value calculated via a classification function based on output of the second fully connected layer is used as a prediction probability of a corresponding category of the sample image patch.

For example, an example in which a pathological image is used for description, after the third fully connected feature is inputted to the second fully connected layer, a corresponding positive probability and a corresponding negative probability of the sample image patch are outputted as the fourth fully connected feature, so that a classification with a high probability is used as a recognition result corresponding to the sample image patch.

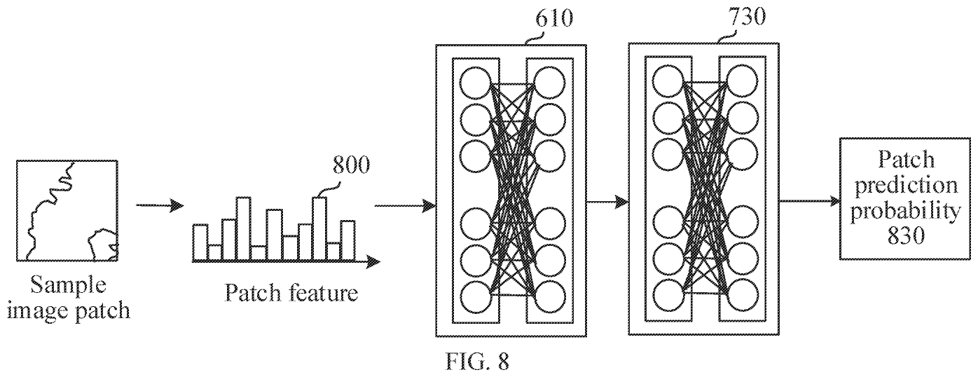

For example, as shown in FIG. 8, after a patch feature 800 corresponding to a sample image patch is obtained, the patch feature 800 is inputted to a first fully connected layer 610, and output of the first fully connected layer 610 is used as input, feature analysis is performed by a second fully connected layer 730, so that a patch prediction probability 830 is outputted.

Step 3044: Determine, based on a difference between the fourth fully connected feature and the patch labels, the second cross entropy loss corresponding to the sample image patches.

In one embodiment, the second cross entropy loss may be calculated with reference to formula 2.

It is inferred that a single patch shares the same fully connected layer with an inference bag, and an inference result is similar to a bag-level prediction, a label constraint of a single patch is accepted, and a direction of gradient descent of a network parameter is pointed out based on a backpropagation of a cross entropy loss.

In one embodiment, a patch label is obtained in the following manners. (1) A patch label is obtained directly from a patch-level label. (2) If a patch label is a pixel-level label, a positive pixel area of the patch is higher than a certain threshold, the patch is considered to be positive; if all pixels in the patch are negative, the patch is considered to be negative; and in other cases, a positive signal of the patch is considered not strong enough, and such patch is discarded and not used for supervision of a patch classification. (3) If the patch comes from a negative sample image, the patch is considered to be negative. (4) For a positive sample image, if a prediction result of a model is correct and has high confidence, then k patches with the greatest corresponding values of an outputted attention layer are extracted as positive patches; and k patches with the smallest corresponding values are extracted as negative patches.

In steps 3041 and 3044, the feature extraction based on the sample image patches and determining of the second cross entropy loss are described. The patch features are obtained after feature extraction of the sample image patches. In addition to performing feature processing on the bag feature, the first fully connected layer in the image recognition model also processes the patch features and obtains the third fully connected feature. In addition to performing feature processing on the first fully connected feature corresponding to the bag feature, the second fully connected layer in the image recognition model also processes the third fully connected feature and obtains the fourth fully connected feature. In other words, the image recognition model not only analyzes the constituted bag feature of the sample patch bag from an overall perspective, but also analyzes the patch features corresponding to the sample image patches from a local perspective. Therefore, the first cross entropy loss corresponding to the sample patch bag can be determined, in addition, the second cross entropy loss corresponding to the sample image patches can be used to implement a robust process for training the image recognition model.

Step 305: Train the image recognition model based on the relative entropy loss, the first cross entropy loss, and the second cross entropy loss.

In one embodiment, the relative entropy loss, the first cross entropy loss, and the second cross entropy loss are weighted and fused to obtain a total loss value, and the image recognition model is trained based on the total loss value.

For example, the total loss value is calculated as shown in formula 3 below.

$${ℒ}_{total} = {λ}_{1} {ℒ}_{c e} ( p , φ ( B ) ) + {λ}_{2} {ℒ}_{c e} ( p , φ ( I ) ) + {λ}_{3} {ℒ}_{kld} ( w , \tilde{w} ) \qquad Formula 3$$

λ₁ is a weight value corresponding to the first cross entropy loss, λ₂ is a weight value corresponding to the second cross entropy loss, λ₃ is a weight value corresponding to the relative entropy loss, and φ(I) is a patch label corresponding to a sample image patch.

In this embodiment of this application, a training set includes two parts: a sample image and a patch. Both the sample image and patch include labels of respective classifications.

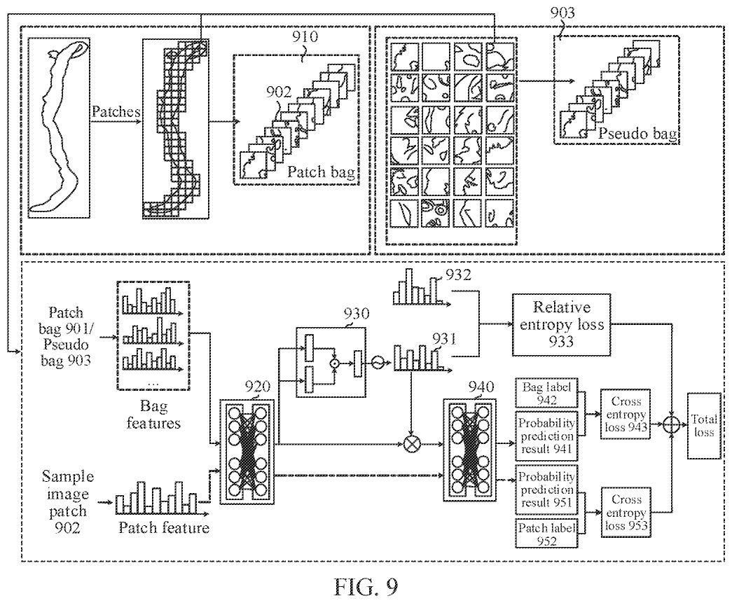

For example, as shown in FIG. 9, during training, input of a model includes three parts: a patch bag 901, patches 902, and a pseudo bag 903 (that is, a bag randomly combined by patches) obtained by segmenting a sample image. A calculation process of a loss value in this embodiment mainly includes the following stages.

### (1) Stage of Calculating a Relative Entropy Loss

For a sample patch bag 910 obtained by segmenting a sample image, such as the foregoing patch bag 901 corresponding to the sample image or the foregoing pseudo bag 903, training data is inputted into a network, and after feature analysis is performed by a first fully connected layer 920, a weighted aggregation feature is outputted based on an attention layer 930 to obtain an attention distribution 931, an expected distribution 932 is obtained based on a label labeling by the sample image, and a relative entropy loss 933 is obtained based on the attention distribution 931 and the expected distribution 932.

### (2) Stage of Calculating a Cross Entropy Loss of a Bag

For the sample patch bag 910 obtained by segmenting the sample image, such as the foregoing patch bag 901 corresponding to the sample image or the foregoing pseudo bag 903, training data is inputted into a network, and after feature analysis is performed by the first fully connected layer 920, feature analysis is performed by a second fully connected layer 940, and a probability prediction result 941 corresponding to a classification category of the sample patch bag 910 is obtained, so that a cross entropy loss 943 of the bag is obtained based on a difference between a bag label 942 and the probability prediction result 941.

### (3) Stage of Calculating a Cross Entropy Loss of a Patch

For the sample image patches 902 obtained by segmenting the sample image, training data is inputted into a network, and after feature analysis is performed by the first fully connected layer 920, feature analysis is performed by a second fully connected layer 940, and a probability prediction result 951 corresponding to a classification category of the sample image patches 902 is obtained, so that a cross entropy loss 953 of the sample image patches is obtained based on a difference between a patch label 952 and the probability prediction result 951.

In conclusion, according to the method in this embodiment, during a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a pathological lesion in a pathological image, to improve efficiency and accuracy of lesion recognition.

In the method according to this embodiment, when sample image patches in a sample patch bag are all negative, a distribution of the sample patch bag is directly determined as a uniform distribution. When a sample image patch in the sample patch bag is positive, an expected distribution is determined based on a patch label of the sample image patch. This improves efficiency for determining the expected distribution, and improves efficiency for training a model.

In the method according to this embodiment, a relative entropy loss and a cross entropy loss are determined respectively for the sample patch bag, and a cross entropy loss is determined for the sample image patches. This adds a dimension for training the model in a weak supervision manner, improves accuracy for training the model, and improves an adaptability of the model.

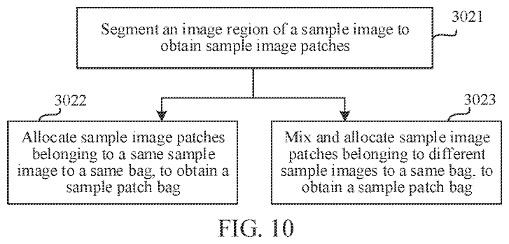

In an embodiment, a sample patch bag may be divided by an image or randomly. FIG. 10 is a flowchart of a method for training an image recognition model according to still another exemplary embodiment of this application. As shown in FIG. 10, step 302 may alternatively be implemented as the following steps.

Step 3021: Segment an image region of the sample image to obtain the sample image patches.

In one embodiment, a manner of segmenting an image region of the sample image is described in step 302. Details are not described herein again.

Step 3022: Allocate sample image patches belonging to a same sample image to a same bag to obtain the sample patch bag.

In some embodiments, all sample image patches belonging to the same sample image are allocated to the same bag to obtain the sample patch bag; or some sample image patches belonging to the same sample image are allocated to the same bag.

When some sample image patches are allocated to the same bag, at least one of the following cases is included.

1. n sample image patches are randomly selected from the sample image patches of the sample image and are allocated to the same bag.

When this allocation method is used, a label corresponding to the sample image indicates that the sample image does not include image content.

2. n sample image patches are selected from a selected position region of the sample image and are allocated to the same bag.

For example, n sequentially adjacent sample image patches are selected starting from a middle position of the sample image and are allocated to the same bag. Alternatively, some sample image patches from regions respectively corresponding to different classifications in the sample image are selected and are allocated to the same bag, the regions respectively corresponding to different classifications are determined based on region labels labeled in the sample image.

3. n sample image patches are skip-selected from the sample image patches of the sample image and are allocated to the same bag.

In other words, one of every two adjacent sample image patches is selected and allocated to the same bag.

The foregoing allocation manners of the sample patch bag are only schematic examples and are not limited in this embodiment.

In one embodiment, a sample label corresponding to the sample image is used, in response to sample image patches in the sample patch bag belonging to a same sample image, as a bag label corresponding to the sample patch bag.

Step 3023: Mix and allocate sample image patches belonging to different sample images to a same bag to obtain the sample patch bag.

In one embodiment, when the sample image patches are mixed and allocated, at least one of the following allocation manners is included.

1. At least one sample image patch is selected from the sample image patches of each sample image, and is allocated to the same bag to obtain the sample patch bag.

A quantity of sample image patches obtained from each sample image may be the same or different.

2. Sample image patches of different sample images are mixed to obtain a patch set, and n sample image patches are randomly obtained from the patch set to constitute the sample patch bag.

3. Some sample image patches are respectively obtained from sample images classified by different labels to constitute the sample patch bag.

The foregoing allocation manners of the sample patch bag are only schematic examples and are not limited in this embodiment.

In one embodiment, the bag label corresponding to the sample patch bag is determined, in response to the sample image patches in the sample patch bag belonging to different sample images, based on the patch labels corresponding to the sample image patches.

In step 3021 to step 3023, the segmenting an image region of the sample image and constituting the sample patch bag based on the sample image patches is described. After the sample image patches after the image region segmentation is obtained, not only sample image patches belonging to the same sample image may be constituted to a sample patch bag, so that a more direct and efficient image analysis process can be performed on the sample image based on the sample patch bag; but also sample image patches belonging to different sample images may be constituted to a sample patch bag, so that cross analysis can be performed on patch relationships corresponding to different sample images, efficiency of patch correlation analysis is greatly improved and a breadth of image analysis is expanded.

In conclusion, according to the method in this embodiment, during a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a pathological lesion in a pathological image, to improve efficiency and accuracy of lesion recognition.

In the method according to this embodiment, sample image patches obtained by segmenting the same sample image are allocated to the same sample patch bag, so that a label corresponding to the sample image patch is used as a bag label, and efficiency of obtaining sample data is improved.

In the method according to this embodiment, sample image patches are obtained from the sample image patches obtained by segmentation of different sample images to constitute a sample patch bag, so that diversity of sample data is improved, and an adaptability of the image recognition model is improved.

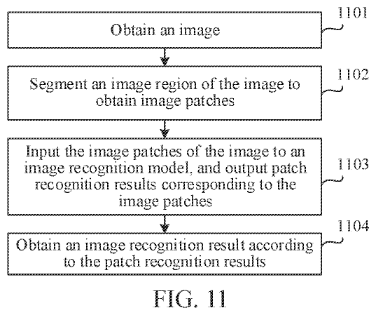

FIG. 11 is a flowchart of an image recognition method according to an exemplary embodiment of this application. The method may be applied to a terminal, or may be applied to a server. In this embodiment, an example in which the method is applied to a server is used for description. As shown in FIG. 11, the method includes the following steps.

Step 1101: Obtain an image.

The image is an image with to-be-recognized image content. In one embodiment, the image is an image with to-be-recognized image content, to be specific, an image is to be inputted to an image recognition model to recognize whether image content is included in the image, and when the image content is included in the image, a region where the image content is located.

For example, when the image recognition method is applied to a pathological image recognition scenario, the image is a to-be-recognized image in a lesion region. When the image recognition method is applied to a traffic image recognition scenario, the image is an image with a to-be-recognized transportation. When the image recognition method is applied to a home video recognition scenario, the images is an image with a to-be-recognized creature (such as a pet or a person).

Step 1102: Segment an image region of the image to obtain image patches.

In one embodiment, the image is segmented into a plurality of image regions of equal size as the image patches. The image patches are used for separate recognition, and image recognition results of all image patches are combined to obtain an image recognition result corresponding to the image.

In other words, during the image recognition, image content is recognized for each image patch, and an inclusion of the image content in each image patch is obtained, so that the recognition results corresponding to all image patches are combined as the recognition result corresponding to the image.

If any image patch includes image content, the image is considered to include the image content; otherwise, if all image patches do not include image content, the image is considered to not include the image content.

Step 1103: Input the image patches of the image to the image recognition model, and output the patch recognition results corresponding to the image patches.

In one embodiment, after the image patches are input to the image recognition model, each image patch is recognized by using the image recognition model, and the patch recognition result corresponding to each image patch is obtained. The patch recognition result indicates the inclusion of the image content in the image patches.

For example, when the image recognition method is applied to a pathological image recognition scenario, the patch recognition result indicates an inclusion of a lesion region in each image patch, and when the image patch includes a lesion region, the patch recognition result also indicates a position of the lesion region in the image patch. When the image recognition method is applied to a traffic image recognition scenario, the patch recognition result indicates an inclusion of a transportation in each image patch, and when the image patch includes a transportation, the patch recognition result also indicates an identifier of the transportation in the image patch, such as a license plate number. When the image recognition method is applied to a home video recognition scenario, the patch recognition result indicates an inclusion of a creature in each image patch, and when the image patch includes a creature, the patch recognition result also indicates a type of the creature in the image patch, such as a pet cat, a pet dog, or a person.

In one embodiment, after the image patches are inputted to the image recognition model, recognition analysis is performed by a first fully connected layer and a second fully connected layer after training, and a probability of each image patch corresponding to a preset category is obtained, so that the patch recognition results of the image patches are obtained.

Step 1104: Obtain the image recognition result according to the patch recognition results.

In one embodiment, if there is any patch recognition result indicating that image content is included in the image patch, the image is considered to include the image content; otherwise, if patch recognition results of all image patches indicate that image content is not included, the image is considered to not include the image content.

In some embodiments, to ensure a screening negative rate and avoid misrecognition of image content, the image patch is reviewed and recognized for the patch recognition result that image content is included in the image patch, for example, the image patches are inputted to the image recognition model again for recognition.

In conclusion, according to the method in this embodiment, during a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a pathological lesion in a pathological image, to improve efficiency and accuracy of lesion recognition.

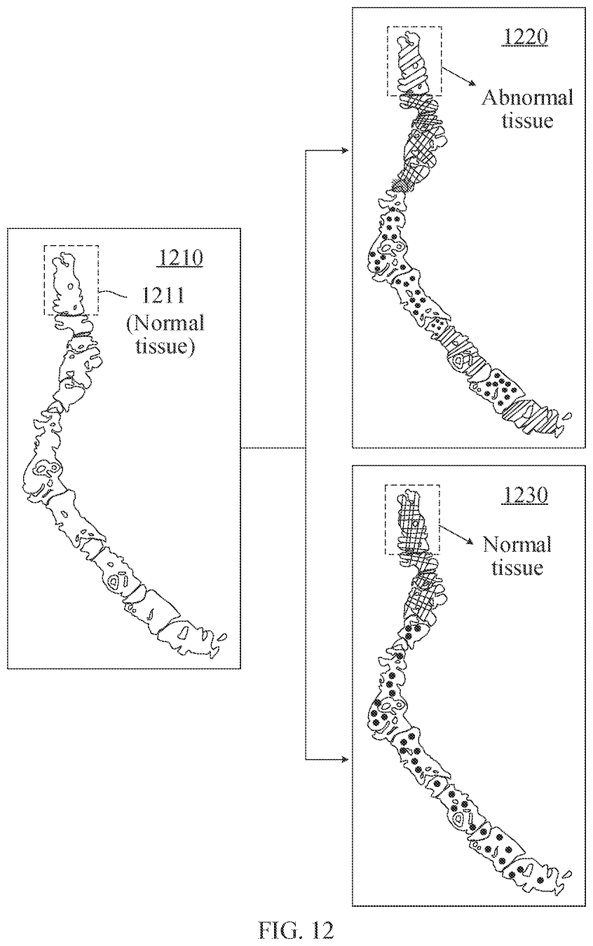

The image recognition model trained in this embodiment of this application has strong robustness and specificity, and has focused attention. Taking pathological image recognition as an example, as shown in FIG. 12, when image recognition is performed on an original image 1210, a model in the related art and an image recognition model according to the embodiments of this application are respectively used. It may be learned from FIG. 12, a result 1220 is obtained by using the image recognition model the related art, and a result 1230 is obtained by using the image recognition model according to the embodiments of this application. Both result 1220 and result 1230 are based on a great attention weight of a corresponding cancer region and give a high attention to remaining suspicious places. The technical solutions according to the embodiments of this application are more focused than the technical solutions according to the related art. A patch represented by a region 1211 is a normal tissue, in the related art, a high attention is provided, but in the embodiments of this application, a low attention is provided. This directly results in a prediction result of the image being positive in the related art, while a network correctly predicts the image to be negative.

For the same test set, different models output different predicted probability distributions. A prediction probability of a positive sample in the technical solutions of the related art is mainly above 0.9, and the positive sample can basically be predicted correctly. A prediction probability of a negative sample tends to be uniformly distributed, and the prediction probability of a positive sample and the prediction probability of a positive sample do not have a large class interval. In the solutions according to the embodiments of this application, most positive samples can also be predicted correctly, and high confidence is achieved, and for a negative sample, a large class interval may be made between prediction results of positive samples and negative samples. In other words, the image recognition model according to the embodiments of this application has strong robustness.

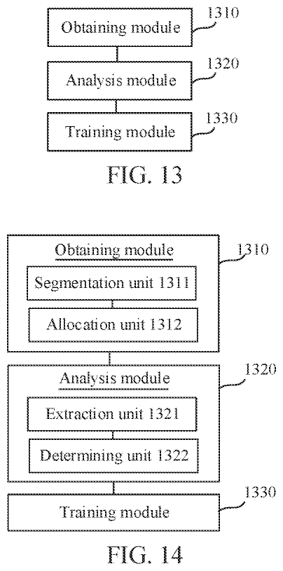

FIG. 13 is a structural block diagram of an apparatus for training an image recognition model according to an exemplary embodiment of this application. As shown in FIG. 13, the apparatus includes the following parts:

An obtaining module 1310 is configured to obtain a sample image set, the sample image set includes a sample image labeled with a sample label, and the sample label indicates an inclusion of image content in the sample image.

The obtaining module 1310 is further configured to: obtain sample image patches corresponding to the sample image, and obtain a sample patch bag based on the sample image patches, the sample patch bag is labeled with a bag label corresponding to the sample label, and the sample image patches is obtained by segmenting an image region of the sample image.

An analysis module 1320 is configured to: perform feature analysis on the sample patch bag by using an image recognition model, and determine, based on a difference between the bag label and a bag analysis result, a relative entropy loss and a first cross entropy loss corresponding to the sample patch bag.

The analysis module 1320 is further configured to: perform feature analysis on the sample image patches by using the image recognition model, and determine, based on a difference between the sample label and a patch analysis result, a second cross entropy loss corresponding to the sample image patches.

A training module 1330 is configured to train the image recognition model based on the relative entropy loss, the first cross entropy loss, and the second cross entropy loss, and the trained image recognition model is configured to recognize image content in an image.

In an embodiment, as shown in FIG. 14, the analysis module 1320 includes:

an extraction unit 1321, configured to perform feature extraction on the sample patch bag by using the image recognition model to obtain a bag feature; and

a determining unit 1322, configured to determine, based on an attention distribution corresponding to the bag feature and an expected distribution corresponding to the bag label, the relative entropy loss corresponding to the sample patch bag the attention distribution being a distribution obtained by predicting image content in the sample patch bag, and the expected distribution being a distribution of the sample patch bag indicated by the bag label.

The determining unit 1322 is further configured to determine, based on a difference between a recognition result of image content recognition of the bag feature and the bag label, the first cross entropy loss corresponding to the sample patch bag.

In an embodiment, the determining unit 1322 is further configured to: perform first feature processing on the bag feature by a first fully connected layer in the image recognition model to obtain a first fully connected feature; and perform attention analysis on the first fully connected feature by an attention layer to obtain an attention distribution corresponding to the sample patch bag.

The determining unit 1322 is further configured to: determine, based on the bag label, an expected distribution corresponding to the sample patch bag; and determine, based on a difference between the attention distribution and the expected distribution, the relative entropy loss corresponding to the sample patch bag.

In an embodiment, the determining unit 1322 is further configured to determine, in response to the bag label indicating that the image content does not exist in the sample image patches in the sample patch bag, that the expected distribution of the sample patch bag is a uniform distribution.

The determining unit 1322 is further configured to: obtain, in response to the bag label indicating that the image content exists in the sample image patches in the sample patch bag, patch labels corresponding to the sample image patches in the bag label; and determine the expected distribution of the sample patch bag based on the patch labels.

In an embodiment, the determining unit 1322 is further configured to determine, in response to the patch labels including classification labels, the expected distribution of the sample patch bag based on classification labels corresponding to the sample image patches, each classification label having a corresponding expected distribution of an instance.

The determining unit 1322 is further configured to determine, in response to the patch labels including the pixel distribution labels, the expected distribution of the sample patch bag based on distributions labeled by the pixel distribution labels, each pixel distribution label is used for regionally labeling pixel content in the sample image patches, and the pixel content indicates a pixel position of the image content in the sample image patches.

In an embodiment, the determining unit 1322 is further configured to perform first feature processing on the bag feature by a first fully connected layer in the image recognition model to obtain a first fully connected feature.

The determining unit 1322 is further configured to: perform second feature processing on the first fully connected feature and an attention distribution corresponding to the sample patch bag by a second fully connected layer in the image recognition model, to obtain a second fully connected feature as a recognition result; and determine, based on a difference between the second fully connected feature and the bag label, the first cross entropy loss corresponding to the sample patch bag.

In an embodiment, the analysis module 1320 includes:
the extraction unit 1321, configured to perform feature extraction on each sample image patch by using the image recognition model to obtain a patch feature; and
the determining unit 1322, configured to: perform first feature processing on the patch feature by the first fully connected layer in the image recognition model to obtain a third fully connected feature; perform second feature processing on the third fully connected feature by a second fully connected layer in the image recognition model, to obtain a fourth fully connected feature as a patch analysis result; and determine, based on a difference between the fourth fully connected feature and the patch labels, the second cross entropy loss corresponding to the sample image patches, the patch labels being labels corresponding to the sample image patches determined based on the sample label.

In an embodiment, the obtaining module 1310 includes:
a segmentation unit 1311, configured to segment an image region of the sample image to obtain the sample image patches;
an allocation unit 1312, configured to allocate sample image patches belonging to a same sample image to a same bag to obtain the sample patch bag; or mix and allocate sample image patches belonging to different sample images to a same bag to obtain the sample patch bag.

In an embodiment, the analysis module 1320 is further configured to: use, in response to the sample image patches in the sample patch bag belonging to a same sample image, a sample label corresponding to the sample image as a bag label corresponding to the sample patch bag.

The analysis module 1320 is further configured to determine, in response to the sample image patches in the sample patch bag belonging to different sample images, the bag label corresponding to the sample patch bag based on patch labels corresponding to the sample image patches.

In an embodiment, the training module 1330 is further configured to: perform weighted fusion on the relative entropy loss, the first cross entropy loss, and the second cross entropy loss to obtain a total loss value; and train the image recognition model based on the total loss value.

In conclusion, for the apparatus according to this embodiment, during a training process of an image recognition model, for an image that requires patch recognition, the image recognition model is trained using sample image patches and a patch bag separately. While overall accuracy of recognizing the sample image is improved, accuracy of recognizing image content in the sample image patches is also improved. This not only avoids a problem of an erroneous recognition result of the entire image due to incorrect recognition of a single image patch, but also increases a screening negative rate when the image recognition model is used to recognize a lesion in a pathological image, to improve efficiency and accuracy of lesion recognition.

The apparatus for training an image recognition model according to the embodiments is illustrated with an example of division of the foregoing function modules. In practical application, the foregoing functions may be allocated to and completed by different function modules according to requirements, in other words, the internal structure of the apparatus is divided into different function modules, to complete the entire or a part of the functions described above. In addition, the apparatus for training an image recognition model according to the embodiments and the method embodiments for training an image recognition model belong to the same concept. For the specific implementation procedure, refer to the method embodiment, and details are not described herein again.

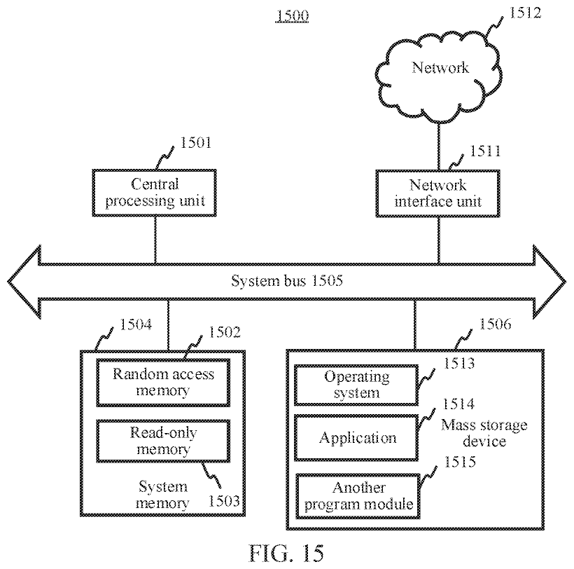

FIG. 15 is a schematic diagram of a structure of a computer device according to an exemplary embodiment of this application. The computer device may be the server shown in FIG. 2.

Specifically, a computer device 1500 includes a central processing unit (CPU) 1501, a system memory 1504 including a random access memory (RAM) 1502 and a read only memory (ROM) 1503, and a system bus 1505 connecting the system memory 1504 to the central processing unit 1501. The computer device 1500 further includes a mass storage device 1506 configured to store an operating system 1513, an application 1514, and another program module 1515.

The mass storage device 1506 is connected to the central processing unit 1501 by using a mass storage controller (not shown) connected to the system bus 1505. Generally, a computer-readable medium may include a computer storage medium and a communication medium.

According to the embodiments of this application, the computer device 1500 may alternatively be connected through a network such as the Internet, to a remote computer on the network to run. To be specific, the computer device 1500 may be connected to a network 1512 by using a network interface unit 1511 connected to the system bus 1505, or may be connected to another type of network or a remote computer system (not shown) by using the network interface unit 1511.

The memory further includes one or more programs that are stored in the memory and are configured to be executed by the CPU.

An embodiment of this application also provides a computer device. The computer device may be implemented as the terminal or the server as shown in FIG. 2. The computer device includes a processor and a memory. The memory has at least one instruction, at least one program, a code set, or an instruction set stored therein. The at least one instruction, the at least one program, the code set, or the instruction set is loaded and executed by the processor to implement the method for training an image recognition model according to the method embodiments of this application.

An embodiment of this application also provides a non-transitory computer-readable storage medium having at least one instruction, at least one program, a code set, or an instruction set stored thereon. The at least one instruction, the at least one program, the code set, or the instruction set is loaded and executed by a processor to implement the method for training an image recognition model according to the method embodiments of this application.

An embodiment of this application also provides a computer program product or a computer program. The computer program product or the computer program includes computer instructions stored in a computer-readable storage medium. A processor of a computer device reads the computer instructions from the computer-readable storage medium, and the processor executes the computer instructions, so that the computer device performs the method for training an image recognition model according to any one of the embodiments.

In one embodiment, the computer-readable storage medium may include: a read-only memory (ROM), a random access memory (RAM), a solid-state drive (SSD), an optical disc, or the like. The random access memory may include a resistance random access memory (ReRAM) and a dynamic random access memory (DRAM). The serial numbers of the embodiments of this application are merely for description, and do not represent the merits of the embodiments.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules. Moreover, each module or unit can be part of an overall module that includes the functionalities of the module

What is claimed is:

1. A method for training an image recognition model, performed by a computer device, the method comprising:
obtaining a sample image and a corresponding sample label;
obtaining a sample image patch bag of sample image patches corresponding to the sample image, the sample patch bag having a bag label corresponding to the sample label of the sample image;
performing feature analysis on the sample patch bag and the sample image patches in the sample patch bag, respectively, by using an image recognition model;
determining a relative entropy loss and a first cross entropy loss corresponding to the sample patch bag based on a difference between the bag label and a corresponding bag feature analysis result and a second cross entropy loss corresponding to the sample image patches based on a difference between the sample label and a corresponding patch analysis result, respectively; and
training the image recognition model based on the relative entropy loss, the first cross entropy loss, and the second cross entropy loss, the trained image recognition model being configured to recognize image content in an image.

2. The method according to claim 1, wherein the determining a relative entropy loss and a first cross entropy loss corresponding to the sample patch bag based on a difference between the bag label and a corresponding bag feature analysis result comprises:
performing feature extraction by using the image recognition model on the sample patch bag to obtain a bag feature;
determining the relative entropy loss corresponding to the sample patch bag based on an attention distribution corresponding to the bag feature and an expected distribution corresponding to the bag label, the attention distribution being a distribution obtained by predicting image content in the sample patch bag, and the expected distribution being a distribution of the sample patch bag indicated by the bag label; and
determining the first cross entropy loss corresponding to the sample patch bag based on a difference between a recognition result of image content recognition of the bag feature and the bag label.

3. The method according to claim 2, wherein the determining the first cross entropy loss corresponding to the sample patch bag based on a difference between a recognition result of image content recognition of the bag feature and the bag label comprises:
performing first feature processing on the bag feature by a first fully connected layer in the image recognition model to obtain a first fully connected feature;
performing second feature processing on the first fully connected feature and an attention distribution corresponding to the sample patch bag by a second fully connected layer in the image recognition model, to obtain a second fully connected feature as a recognition result; and
determining, based on a difference between the second fully connected feature and the bag label, the first cross entropy loss corresponding to the sample patch bag.

4. The method according to claim 1, wherein the determining a second cross entropy loss corresponding to the sample image patches based on a difference between the sample label and a patch feature analysis result comprises:
performing feature extraction on each sample image patch by using the image recognition model to obtain a patch feature;
performing first feature processing on the patch feature by the first fully connected layer in the image recognition model to obtain a third fully connected feature;
performing second feature processing on the third fully connected feature by a second fully connected layer in the image recognition model, to obtain a fourth fully connected feature as a patch analysis result; and
determining, based on a difference between the fourth fully connected feature and the patch labels, the second cross entropy loss corresponding to the sample image patches, the patch labels being labels corresponding to the sample image patches determined based on the sample label.

5. The method according to claim 1, wherein the obtaining a sample image patch bag of sample image patches corresponding to the sample image comprises:
segmenting an image region of the sample image to obtain the sample image patches; and
allocating sample image patches belonging to a same sample image to a same bag to obtain the sample patch bag.

6. The method according to claim 5, wherein the method further comprises:
using, in response to the sample image patches in the sample patch bag belonging to a same sample image, a sample label corresponding to the sample image as a bag label corresponding to the sample patch bag; and
determining, in response to the sample image patches in the sample patch bag belonging to different sample images, the bag label corresponding to the sample patch bag based on the patch labels corresponding to the sample image patches.

7. The method according to claim 1, wherein the training the image recognition model based on the relative entropy loss, the first cross entropy loss, and the second cross entropy loss comprises:
performing weighted fusion on the relative entropy loss, the first cross entropy loss, and the second cross entropy loss to obtain a total loss value; and
training the image recognition model based on the total loss value.

8. A computer device, comprising a processor and a memory, the memory having at least one program stored therein that, when executed by the processor, causes the computer device to implement a method for training an image recognition model including:
obtaining a sample image and a corresponding sample label;
obtaining a sample image patch bag of sample image patches corresponding to the sample image, the sample patch bag having a bag label corresponding to the sample label of the sample image;
performing feature analysis on the sample patch bag and the sample image patches in the sample patch bag, respectively, by using an image recognition model;
determining a relative entropy loss and a first cross entropy loss corresponding to the sample patch bag based on a difference between the bag label and a corresponding bag feature analysis result and a second cross entropy loss corresponding to the sample image patches based on a difference between the sample label and a corresponding patch analysis result, respectively; and
training the image recognition model based on the relative entropy loss, the first cross entropy loss, and the second cross entropy loss, the trained image recognition model being configured to recognize image content in an image.

9. The computer device according to claim 8, wherein the determining a relative entropy loss and a first cross entropy loss corresponding to the sample patch bag based on a difference between the bag label and a corresponding bag feature analysis result comprises:
performing feature extraction by using the image recognition model on the sample patch bag to obtain a bag feature;
determining the relative entropy loss corresponding to the sample patch bag based on an attention distribution corresponding to the bag feature and an expected distribution corresponding to the bag label, the attention distribution being a distribution obtained by predicting image content in the sample patch bag, and the expected distribution being a distribution of the sample patch bag indicated by the bag label; and
determining the first cross entropy loss corresponding to the sample patch bag based on a difference between a recognition result of image content recognition of the bag feature and the bag label.

10. The computer device according to claim 9, wherein the determining the first cross entropy loss corresponding to the sample patch bag based on a difference between a recognition result of image content recognition of the bag feature and the bag label comprises:
performing first feature processing on the bag feature by a first fully connected layer in the image recognition model to obtain a first fully connected feature;
performing second feature processing on the first fully connected feature and an attention distribution corresponding to the sample patch bag by a second fully connected layer in the image recognition model, to obtain a second fully connected feature as a recognition result; and
determining, based on a difference between the second fully connected feature and the bag label, the first cross entropy loss corresponding to the sample patch bag.

11. The computer device according to claim 8, wherein the determining a second cross entropy loss corresponding to the sample image patches based on a difference between the sample label and a patch feature analysis result comprises:
performing feature extraction on each sample image patch by using the image recognition model to obtain a patch feature;
performing first feature processing on the patch feature by the first fully connected layer in the image recognition model to obtain a third fully connected feature;
performing second feature processing on the third fully connected feature by a second fully connected layer in the image recognition model, to obtain a fourth fully connected feature as a patch analysis result; and
determining, based on a difference between the fourth fully connected feature and the patch labels, the second cross entropy loss corresponding to the sample image patches, the patch labels being labels corresponding to the sample image patches determined based on the sample label.

12. The computer device according to claim 8, wherein the obtaining a sample image patch bag of sample image patches corresponding to the sample image comprises:
segmenting an image region of the sample image to obtain the sample image patches; and
allocating sample image patches belonging to a same sample image to a same bag to obtain the sample patch bag.

13. The computer device according to claim 12, wherein the method further comprises:
using, in response to the sample image patches in the sample patch bag belonging to a same sample image, a sample label corresponding to the sample image as a bag label corresponding to the sample patch bag; and
determining, in response to the sample image patches in the sample patch bag belonging to different sample images, the bag label corresponding to the sample patch bag based on the patch labels corresponding to the sample image patches.

14. The computer device according to claim 8, wherein the training the image recognition model based on the relative entropy loss, the first cross entropy loss, and the second cross entropy loss comprises:
performing weighted fusion on the relative entropy loss, the first cross entropy loss, and the second cross entropy loss to obtain a total loss value; and
training the image recognition model based on the total loss value.

15. A non-transitory computer-readable storage medium, having at least one program stored thereon that, when executed by a processor of a computer device, causes the computer device to implement a method for training an image recognition model including:
obtaining a sample image and a corresponding sample label;
obtaining a sample image patch bag of sample image patches corresponding to the sample image, the sample patch bag having a bag label corresponding to the sample label of the sample image;
performing feature analysis on the sample patch bag and the sample image patches in the sample patch bag, respectively, by using an image recognition model;
determining a relative entropy loss and a first cross entropy loss corresponding to the sample patch bag based on a difference between the bag label and a corresponding bag feature analysis result and a second cross entropy loss corresponding to the sample image patches based on a difference between the sample label and a corresponding patch analysis result, respectively; and
training the image recognition model based on the relative entropy loss, the first cross entropy loss, and the second cross entropy loss, the trained image recognition model being configured to recognize image content in an image.

16. The non-transitory computer-readable storage medium according to claim 15, wherein the determining a relative entropy loss and a first cross entropy loss corresponding to the sample patch bag based on a difference between the bag label and a corresponding bag feature analysis result comprises:
performing feature extraction by using the image recognition model on the sample patch bag to obtain a bag feature;
determining the relative entropy loss corresponding to the sample patch bag based on an attention distribution corresponding to the bag feature and an expected distribution corresponding to the bag label, the attention distribution being a distribution obtained by predicting image content in the sample patch bag, and the expected distribution being a distribution of the sample patch bag indicated by the bag label; and
determining the first cross entropy loss corresponding to the sample patch bag based on a difference between a recognition result of image content recognition of the bag feature and the bag label.

17. The non-transitory computer-readable storage medium according to claim 16, wherein the determining the first cross entropy loss corresponding to the sample patch bag based on a difference between a recognition result of image content recognition of the bag feature and the bag label comprises:
performing first feature processing on the bag feature by a first fully connected layer in the image recognition model to obtain a first fully connected feature;
performing second feature processing on the first fully connected feature and an attention distribution corresponding to the sample patch bag by a second fully connected layer in the image recognition model, to obtain a second fully connected feature as a recognition result; and
determining, based on a difference between the second fully connected feature and the bag label, the first cross entropy loss corresponding to the sample patch bag.

18. The non-transitory computer-readable storage medium according to claim 15, wherein the determining a second cross entropy loss corresponding to the sample image patches based on a difference between the sample label and a patch feature analysis result comprises:
performing feature extraction on each sample image patch by using the image recognition model to obtain a patch feature;
performing first feature processing on the patch feature by the first fully connected layer in the image recognition model to obtain a third fully connected feature;
performing second feature processing on the third fully connected feature by a second fully connected layer in the image recognition model, to obtain a fourth fully connected feature as a patch analysis result; and
determining, based on a difference between the fourth fully connected feature and the patch labels, the second cross entropy loss corresponding to the sample image patches, the patch labels being labels corresponding to the sample image patches determined based on the sample label.

19. The non-transitory computer-readable storage medium according to claim 15, wherein the obtaining a sample image patch bag of sample image patches corresponding to the sample image comprises:
segmenting an image region of the sample image to obtain the sample image patches; and
allocating sample image patches belonging to a same sample image to a same bag to obtain the sample patch bag.

20. The non-transitory computer-readable storage medium according to claim 15, wherein the training the image recognition model based on the relative entropy loss, the first cross entropy loss, and the second cross entropy loss comprises:
performing weighted fusion on the relative entropy loss, the first cross entropy loss, and the second cross entropy loss to obtain a total loss value; and
training the image recognition model based on the total loss value.
